(19) United States
(12) Patent Application Publication
(10) Pub. No.: US 2011/0297042 A1
(43) Pub. Date: Dec. 8, 2011

(54) Biostable cellulose ethers in nonaqueous dispersion and emulsion paint prepared therewith

(76) Inventors: Heiko GALLER, Soergenloch (DE); Juergen FISCHER, Wiesbaden (DE); Leif BERGER, Mainz (DE)

(21) Appl. No.: 13/114,088

(22) Filed: May 24, 2011

(30) Foreign Application Priority Data
Jun. 2, 2010 (DE) 10 2010 022 463.4

(51) Int. Cl. C09D 101/28; C09D 191/00

(52) U.S. Cl. 106/179.1; 106/172.1; 106/196.1; 106/197.01

(57) ABSTRACT

The present invention relates to a substantially anhydrous suspension incorporating at least one biostable hydroxyalkylcellulose having an MS of 1.0 to 3.0, at least one oil, and at least one defoamer. The cellulose ether is preferably a hydroxyethylcellulose (HEC) having an MS of 1.0 to 3.0, preferably of 1.8 to 2.8, more preferably about 2.4. The oil is preferably a natural oil. Further disclosed is an emulsion paint, more particularly for interior coatings, which includes this suspension. It is particularly resistant to enzymes having a cellulytic action (cellulases), and this is manifested in a reduced fall in viscosity.

### CROSS-REFERENCE TO RELATED APPLICATIONS

This application claims priority to German Patent Application 10 2010 022 463.4 filed Jun. 2, 2010 which is hereby incorporated herein by reference in its entirety.

### FIELD OF THE INVENTION

The invention relates to a nonaqueous, substantially anhydrous dispersion of cellulose ethers which are biostable—that is, substantially resistant to degradation by enzymes having a cellulytic action. It relates, furthermore, to coating materials prepared therewith, especially the emulsion paints, which are suitable more particularly for interior coating.

### BACKGROUND OF THE INVENTION

Biostable hydroxyethylcelluloses and processes for preparing them are known from, for example DE 27 51 411 (=U.S. Pat. No. 4,084,060) and DE 42 13 329 (=U.S. Pat. No. 5,493,013). In the preparation process, cellulose is hydroxyethylated with ethylene oxide, in an aqueous suspension which further comprises an organic dispersant and NaOH. In the reaction with the ethylene oxide, the ratio of sodium hydroxide to cellulose is first set to about 0.3 to 0.35 until an MS of 0.6 to 1.3 is reached. Thereafter the ratio is reduced to about 0.06 to 0.12 and the hydroxyethylation is continued until an HEC with an MS of about 3.6 to 6.0 is obtained. This is achieved through partial or complete neutralization of the sodium hydroxide. It is assumed that this procedure reduces the proportion of unsubstituted hydroxyl groups in the cellulose, and this lowers the susceptibility to enzymatic degradation.

According to DE '411, the use of cellulose ethers as thickeners in aqueous latex paints was known. The cellulose ethers have hitherto been added almost exclusively in the form of powder. Powder, however, is difficult to meter, entails dust, and takes time to dissolve in the paint.

Enzymes having a cellulytic action, of the kind that are formed in particular by molds, are able to degrade cellulose ethers. As a result of such degradation, the paint becomes runny and runs off from vertical substrates. A paint of this kind is generally considered to have “gone off”. In order to prevent this, aqueous latex paints or emulsion paints generally include biocidal agents.

The reduction in viscosity under the action of cellulytic enzymes is also set out in the article by R. Donges, “Entwicklungen in der Herstellung and Anwendung von Celluloseethern” [Developments in the preparation and use of cellulose ethers], in DAS PAPIER December 1997, pp. 653-660, especially page 658, FIG. 20.

U.S. Pat. No. 6,306,933 B1 discloses dispersions of water-soluble cellulose ethers. Cellulose ethers identified specifically include hydroxyethylcellulose (HEC), hydroxypropylcellulose (HPC), methylcellulose (MC), methylhydroxypropylcellulose (MHPC), and methylhydroxyethylcellulose (MHEC). The dispersions contain 1 to 75% by weight of cellulose ether and 99 to 25% by weight, based in each case on the total weight of the dispersion, of an oxygen-containing organic dispersant which for the cellulose ether constitutes “nonsolvent”. The liquid phase in the dispersion is preferably comprised of ketones, carbonates, esters, ester alcohols and/or glycol ethers. Those identified specifically include ethyl methyl ketone, propylene carbonate, ethylene carbonate, ethyl propionate and n-propyl propionate, 2-ethoxyethyl acetate, and diethylene glycol monobutyl ether acetate. The dispersion may further comprise thickeners, an example being hydrophobized silica. The cellulose ether dispersions are used in particular for preparing latex paints on an aqueous basis. They have the disadvantage, however, that they contain volatile organic compounds (VOCs), which may escape into the surrounding air.

DE 31 35 892 (=U.S. Pat. No. 4,566,977) relates to nonaqueous suspensions of water-soluble cellulose ethers. As well as 1 to 60% by weight of a water-soluble cellulose ether, these suspensions contain 20 to 95% by weight of a water-insoluble liquid hydrocarbon, 1 to 10% by weight of a nonionic surface-active agent having an HLB of 7 to 14, 1 to 4% by weight of an organically modified clay, and 1 to 10% by weight of a stabilizer. The liquid hydrocarbon is preferably mineral oil, kerosene, diesel or naphtha. The suspensions are suitable for thickening liquids of the kind needed for oil wells or gas wells, or for thickening completion fluids.

Also known, lastly, are HECs which are in solution in aqueous salt solutions. The salt solutions include a considerable fraction of salt, such as of sodium formiate or magnesium chloride, for example. Solutions of this kind are available, for example, under the name ADMIRAL® or NATROSOL® FPS (Fluidized Polymer Suspension) from the Aqualon Company, Wilmington, Del. Salt solutions of this kind, however, have a strongly corrosive effect. Emulsion paints prepared with aqueous HEC salt solutions of this kind, moreover, have poor shelf life. As a result of the salt, furthermore, the wet abrasion resistance of the paint coatings is often adversely affected.

### SUMMARY OF ADVANTAGEOUS EMBODIMENTS OF THE INVENTION

A problem which continues to exist, therefore, is that of providing a cellulose ether in liquid form which is stable toward enzymatic degradation, which can be metered easily without producing dust, and which can be incorporated easily and quickly into an aqueous emulsion paint. The cellulose ether dispersion is as far as possible to be free from inorganic salts and not to be corrosive. It is to contain as small as possible a fraction of volatile organic compounds (VOCs). Moreover, the dispersion is to include a high fraction of cellulose ether.

The problem has been solved by a dispersion of biostable cellulose ethers in a liquid phase which is substantially free of water or of other solvents for cellulose ethers.

The liquid phase comprises a combination of a natural or synthetic oil and a defoamer.

### BRIEF DESCRIPTION OF THE DRAWINGS

FIG. 1 graphically illustrates the fall in viscosity of the 1% solutions from Example 1 and Comparative Example 2; and

FIG. 2 graphically illustrates the falling viscosity of the paint from Comparative Example 4 and Example 5.

### DETAILED DESCRIPTION OF ADVANTAGEOUS EMBODIMENTS OF THE INVENTION

The invention accordingly provides a substantially anhydrous suspension which comprises at least one biostable hydroxylalkylcellulose having an MS of 1.0 to 3.0, at least one oil, and at least one defoamer. The cellulose ether is preferably a hydroxyethylcellulose (HEC) having an MS of 1.0 to 3.0, preferably of 1.8 to 2.8, more preferably about 2.4.

The suspension of the invention is prepared using a biostable hydroxyalkylcellulose, preferably a biostable hydroxyethylcellulose. In the preparation of this hydroxyalkylcellulose, cellulose is hydroxyalkoxylated with alkylene oxide, more particularly with ethylene oxide, in an aqueous suspension which optionally further comprises an organic dispersant and NaOH. In the reaction with the alkylene oxide, in the first step, the ratio of sodium hydroxide to cellulose is first set to about 0.8 to 2.0 mol(NaOH)/mol(cellulose) and hydroxyalkoxylation takes place to an MS of 0.6 to 1.3. Thereafter the ratio is reduced to about 0.01 to 0.6 and the hydroxyalkoxylation is continued to an MS of about 1.0 to 4.0.

The oil is preferably a natural oil, more particularly a mineral oil or a medical white oil. Besides or else additionally, synthetic oils may be used. These include, more particularly, natural oils such as castor oil, sunflower oil or rapeseed oil and esters thereof, more particularly the rapeseed oil methyl ester (RME) that is known as “biodiesel”, alkoxylated triglycerides or organic solvents which do not, or not significantly, dissolve the cellulose ether or ethers in question.

The defoamer is preferably a hydrophobic silica or a wax, especially a montan wax.

In one preferred embodiment the biostable cellulose ether is a nonionic cellulose ether, more preferably a hydroxyalkylcellulose, especially hydroxyethylcellulose (HEC). The MS (HE) of the HEC is preferably 1.0 to 3.0, more particularly 1.5 to 2.8, and the average degree of polymerization DP_{w} of the HEC is about 10 to 3000. It was surprising that a hydroxyalkylcellulose having a relatively low MS by comparison with the prior art exhibits such a high biostability.

The fraction of hydroxyalkylcellulose is generally about 15 to 75% by weight, preferably about 20 to 60% by weight, more preferably about 30 to 50% by weight, more particularly about 40% by weight, based in each case on the total weight of the suspension.

Oil and defoamer together have a fraction of about 25 to 85% by weight, preferably about 40 to 80% by weight, more preferably about 50 to 70% by weight, more particularly about 60% by weight, based in each case on the total weight of the suspension.

“Substantially anhydrous” in the context of the present invention means that the suspension contains less than 3% by weight, preferably less than 2% by weight, more preferably less than 1% by weight, of water, based in each case on the total weight of the suspension.

A hydroxyalkylcellulose is termed “biostable” in connection with the present invention if the Brookfield viscosity RVT of a 1% strength by weight aqueous solution thereof at a temperature of 20° C.±0.1° C., determined using spindle 5 at 20 revolutions per minute, shows a drop of not more than 20%, preferably not more than 15%, over the course of 4 hours on exposure to a 0.05% strength by weight cellulase solution (for example, an Aspergillus niger solution).

Suitable combinations oil and defoamer are available commercially.

The biostable cellulose ethers may be prepared more particularly in accordance with the method described in the abovementioned DE 27 51 411 (=U.S. Pat. No. 4,084,060), in which the alkali fraction is reduced during the etherification. Reaction here takes place exclusively with alkylene oxides, more particularly with ethylene oxide. The hydroxyalkyl-cellulose used in the suspension of the invention, accordingly, contains no other ether groups.

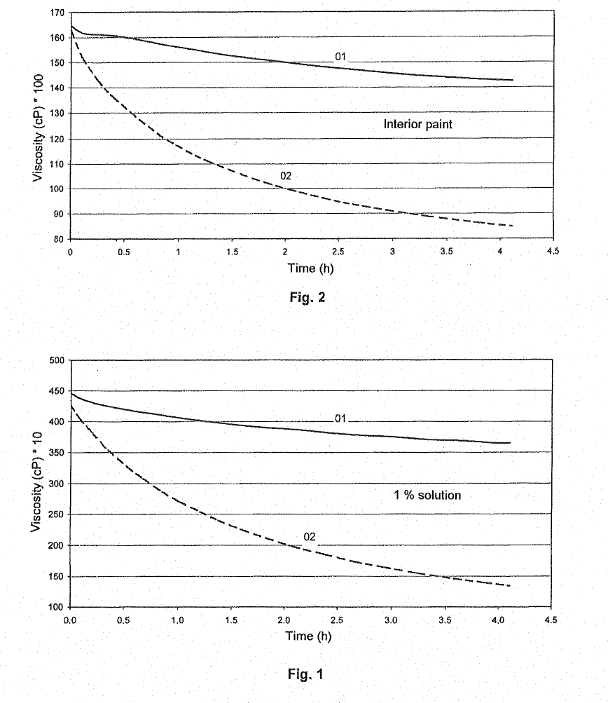

The suspension of the invention is substantially more stable toward enzymatic degradation than a suspension prepared with conventional cellulose ethers. This is evident from a sharply reduced viscosity reduction, as shown in FIG. 1. There, the viscosity of a 1% strength by weight aqueous solution of a biostable HEC is contrasted with the viscosity of the corresponding solution of a conventional HEC.

Further provided with the present invention is an emulsion paint prepared with the nonaqueous suspension described. In comparison to a conventional emulsion paint, the emulsion paint of the invention is substantially more stable toward enzymes of the kind formed in particular by molds (Aspergillus niger, etc.). This is evident from a substantially lower decrease in viscosity (see FIG. 2). The fraction of the cellulose ether suspension of the invention as a proportion of the emulsion paint of the invention is generally 0.001 to 10% by weight, preferably 0.01 to 1.0% by weight, based in each case on the total weight of the paint. The emulsion paint contains generally less than 10% by weight, preferably less than 5% by weight, more preferably less than 3% by weight, based in each case on its total weight, of organic solvents. It is particularly suitable for coating interior and exterior walls of buildings.

The emulsion paint of the invention is particularly resistant to mold infestation and therefore exhibits improved storage stability—that is, its consistency is retained for a longer time. Coatings produced therewith, moreover, exhibit high abrasion resistance.

Also part of the present invention, lastly, is a process for preparing the stated emulsion paint. A key feature of the process is that a nonaqueous dispersion of the biostable cellulose ether described is incorporated. The dispersion of the invention can be metered in substantially more easily and quicker, and can also be incorporated uniformly and in dust-free form, than a cellulose ether in powder form. The cellulose ether acts as a thickener in the emulsion paint. The suspension of the invention has the further advantage that it can be added at virtually any point in time during paint preparation. Hence there is no need to add in any particular sequence, and there is also no need to wait for the cellulose ether to undergo preliminary swelling after it has been added.

The examples below serve to illustrate the invention. Percentages there should be understood as percentages by weight, unless otherwise indicated or immediately evident from the context. “pbw” stands for part(s) by weight. The viscosity of the cellulose ethers was determined using a Brookfield rotational viscometer, model RVT.

### Example 1

### Nonaqueous Suspension of a Biostable HEC

A suspension was prepared from
40 pbw of a hydroxyethylcellulose having an MS (HE) of 2.4 to 2.8 and a Brookfield RV viscosity, determined on a 1% strength aqueous solution of the absolutely dry cellulose ether in water (20° dH) [German hardness] using spindle 4, rpm, of about 4900 mPa s (HS 100000 YP2 from SE Tylose GmbH and Co. KG) and
60 pbw of a combination of modified, nonionic fatty substances, hydrophobic silica, and aromatics-free medical white oils (AGITAN® 265 from Münzing Chemie GmbH).

The biostability of the HEC was determined on a 1% strength aqueous solution whose composition was as follows:
12.5 pbw of HS 100000 YP2
5 pbw of 0.5% aqueous ammonia
482.5 pbw of water (20° German hardness), and
5 pbw of a cellulase solution prepared from 0.1 pbw of cellulase and 500 pbw of fully demineralized water.

The Brookfield RVT viscosity of the solution at 20° C. was determined immediately after addition of the cellulase and also after 4 hours of stirring at 20° C. in the presence of the cellulase. A spindle 5 was used at 20 revolutions per minute.

While the viscosity at the start was still 4400 mPa s, it had dropped after 4 hours to 3640 mPa s.

### Example 2

### Nonaqueous Suspension of a Conventional HEC

### Comparative Example

A suspension was prepared from
40 pbw of a hydroxyethylcellulose have an MS of 2.4 to 2.8 and a Brookfield RV viscosity, spindle 4, rpm, measured on a 1% strength solution with the absolutely dry cellulose ether in water (20° dH) at 20° C., at 1270 mPa s (H 100000 YP2 from SE Tylose GmbH and Co. KG) and
60 pbw of AGITAN® 265.

The biostability of this HEC was investigated on the basis of a composition which was the same as that in example 1 except that the biostable HEC was replaced by the abovementioned conventional HEC.

The measure taken for the biostability was, as in example 1, the reduction in viscosity. The measuring conditions were the same as in example 1. The Brookfield viscosity fell from 4260 mPa s at the start of the experiment to 1360 mPa s after 4 hours. The reduction in viscosity was therefore substantially greater than in example 1.

TABLE 1

| | Brookfield RVT | Brookfield RVT viscosity* |
|---|---|---|
| | viscosity* | after cellulase |
| | original [mPa s] | exposure** [mPa s] |
| Example 1 | 4400 | 3640 |
| Example 2 | 4260 | 1360 |

*Spindle 5, 20 revolutions per minute, at 20° C.
**Determined using spindle 5, 20 rpm, at 20° C., after 4 hours of exposure to cellulase at 20° C.

A graph of the fall in viscosity of the 1% solutions from examples 1 and 2 is attached as FIG. 1.

### Example 3

### Emulsion Paint Prepared with Conventional HEC in Powder Form

### Comparative Example

An emulsion paint for interior coatings was prepared by introducing
297.75 pbw of water (20° dH) and adding,
2.0 pbw of preservative (Mergal K 9 N),
1.0 pbw of preservative (Calgon N), and
2.0 pbw of wetting agent (Tego DISPERS° 715 W). Then
2.5 pbw of HEC (HS 100000 YP2 from SE Tylose GmbH & Co. KG), and also
75.0 pbw of titanium dioxide white pigment (Kronos 2043),
420.0 pbw of precipitated carbonate filler (Omyacarb 5 GU),
50.0 pbw of precipitated carbonate filler (Omyacarb EXTRA° GU),
25.0 pbw of filler (China Clay Grade B),
1.0 pbw of 10% strength by weight aqueous sodium hydroxide solution, and
120.0 pbw of ethylene/vinyl acetate copolymer dispersion having a solids content of 53% (MOWILITH® LDM 1871), were added.

To test the biostability, the emulsion paint was treated with 5 pbw of the Aspergillus niger cellulase solution described in example 1, and the viscosity was determined immediately after the addition. The viscosity was determined again after 4 hours. The results are compiled in the table below.

### Example 4

### Emulsion Paint Prepared with Conventional HEC in the Form of a Nonaqueous Suspension

### Comparative Example

An emulsion paint for interior coatings was prepared by introducing
297.75 pbw of water (20° dH) and adding,
2.0 pbw of preservative (Mergal K 9 N),
1.0 pbw of preservative (Calgon N), and
2.0 pbw of wetting agent (Tego DISPERS® 715 W). Then
6.25 pbw of HEC (H 100000 YP2 from SE Tylose GmbH & Co. KG), in liquid form, containing 3.75 pbw of AGITAN® 256, were added, and also
75.0 pbw of titanium dioxide white pigment (Kronos 2043),
420.0 pbw of precipitated carbonate filler (Omyacarb 5 GU),
50.0 pbw of precipitated carbonate filler (Omyacarb EXTRA® GU),
25.0 pbw of filler (China Clay Grade B),
1.0 pbw of 10% strength by weight aqueous sodium hydroxide solution, and
120.0 pbw of ethylene/vinyl acetate copolymer dispersion having a solids content of 53% (MOWILITH® LDM 1871), were added.

To test the biostability, the emulsion paint was treated with 5 pbw of the Aspergillus niger cellulase solution described in example 1, and the viscosity was determined immediately after the addition. The viscosity was determined again after 4 hours. The results are compiled in the table below.

### Example 5

### Emulsion Paint Prepared with an Inventive HEC Suspension

An emulsion paint for interior coatings was prepared by introducing
297.75 pbw of water and adding,
2.0 pbw of preservative (Mergal K 9 N),
1.0 pbw of preservative (Calgon N), and
2.0 pbw of wetting agent (Tego DISPERS® 715 W). Then
6.25 pbw of biostable HEC (HS 100000 YP2 from SE Tylose GmbH & Co. KG), in liquid form, containing 3.75 pbw of AGITAN® 265, were added, and also
75.0 pbw of titanium dioxide white pigment (Kronos 2043),
420.0 pbw of precipitated carbonate filler (Omyacarb 5 GU),
50.0 pbw of precipitated carbonate filler (Omyacarb EXTRA® GU),
25.0 pbw of filler (China Clay Grade B),
1.0 pbw of 10% strength by weight aqueous sodium hydroxide solution, and
120.0 pbw of ethylene/vinyl acetate copolymer dispersion having a solids content of 53% (MOWILITH® LDM 1871), were added.

As described in example 4, the viscosity of the emulsion paint was determined immediately after addition of the cellulase, and then again after 4 hours' exposure to the cellulase.

TABLE 2

| | Brookfield | Brookfield | |
|---|---|---|---|
| | viscosity***, | viscosity***, | Degradation |
| | immediate | after 4 hours | quotient |
| | [mPa s] | [mPa s] | DQ**** |
| Example 3 | 16 700 | 12 985 | 0.78 |
| (comparative) | | | |
| Example 4 | 16 800 | 8 480 | 0.50 |
| (comparative) | | | |
| Example 5 | 16 600 | 14 240 | 0.86 |

***Determined using spindle 5, 10 revolutions per minute at 20° C.; Brookfield viscometer RVT
****Degradation quotient (DQ) = viscosity after 4 h/viscosity at the start

A graph of the falling viscosity of the paint from comparative example 4 and from example 5 is attached as FIG. 2.

As clearly shown by the data in table 2 and FIG. 2, the drop in viscosity is much smaller for the emulsion paint prepared with the liquid HEC of the invention. This also means that this paint is more durable and hence has a longer storage life.

That which is claimed:

1. A substantially anhydrous suspension comprising at least one biostable hydroxyalkylcellulose having an MS of 1.0 to 3.0, at least one oil, and at least one defoamer.

2. The suspension as claimed in claim 1, wherein the hydroxyalkylcellulose is a hydroxyethylcellulose.

3. The suspension as claimed in claim 1, wherein the hydroxyalkylcellulose has an MS of 1.5 to 2.8, and/or an average degree of polymerization DP_{w} of 10 to 3000.

4. The suspension as claimed in claim 3, wherein the hydroxyalkylcellulose has an MS of about 2.4.

5. The suspension as claimed in claim 1, wherein the oil is a natural oil, a mineral oil or a medical white oil, a synthetic oil, an alkoxylated triglyceride, an organic solvent which does not, or not significantly, dissolve the cellulose ether, or a mixture thereof.

6. The suspension as claimed in claim 5, wherein the natural oil is castor oil, sunflower oil or rapeseed oil, and the synthetic oil is rapeseed oil alkyl ester.

7. The suspension as claimed in claim 1, wherein the defoamer is a hydrophobic silica or a wax.

8. The suspension as claimed in claim 7, wherein the wax, is a montan wax.

9. The suspension as claimed in claim 1, wherein the fraction of hydroxylalkylcellulose is 15 to 75% by weight, based on the total weight of the suspension.

10. The suspension as claimed in claim 9, wherein the fraction of hydroxylalkylcellulose is 20 to 60% by weight, based on the total weight of the suspension.

11. The suspension as claimed in claim 10, wherein the fraction of hydroxylalkylcellulose is 30 to 50% by weight, based on the total weight of the suspension.

12. The suspension as claimed in claim 11, wherein the fraction of hydroxylalkylcellulose is about 40% by weight, based on the total weight of the suspension.

13. The suspension as claimed in claim 1, wherein the fraction of oil and defoamer together is 25 to 85% by weight, based on the total weight of the suspension.

14. The suspension as claimed in claim 13, wherein the fraction of oil and defoamer together is about 40 to 80% by weight, based on the total weight of the suspension.

15. The suspension as claimed in claim 13, wherein the fraction of oil and defoamer together is about 50 to 70% by weight, based on the total weight of the suspension.

16. The suspension as claimed in claim 13, wherein the fraction of oil and defoamer together is about 60% by weight, based on the weight of the suspension.

17. The suspension as claimed in claim 1, wherein water is present in a fraction of less than 3% by weight, based on the total weight of the suspension.

18. The suspension as claimed in claim 17, wherein the fraction of water is less than 2% by weight, based on the total weight of the suspension.

19. The suspension as claimed in claim 17, wherein the fraction of water is less than 1% by weight, based on the total weight of the suspension.

20. An emulsion paint comprising a hydroxyalkylcellulose suspension as claimed in claim 1.

21. The emulsion paint as claimed in claim 20, further comprising less than 10% by weight, based on its total weight, of organic solvents.

22. The emulsion paint as claimed in claim 20, further comprising less than 5% by weight, based on its total weight, of organic solvents.

23. The emulsion paint as claimed in claim 20, further comprising less than 3% by weight, based on its total weight, of organic solvents.

24. A process for preparing an emulsion paint as claimed in claim 20 comprising admixing therein the suspension as claimed in claim 1 in a fraction of 0.001 to 10% by weight, based on the total weight of the emulsion paint.

25. Interior coatings comprising the emulsion paint as claimed in claim 20.
